(19) United States
(12) Patent Application Publication
(10) Pub. No.: US 2024/0402520 A1
(43) Pub. Date: Dec. 5, 2024

(54) GLASSES FRAME COMPRISING AT LEAST ONE PORTION OF AN ELECTRONIC DEVICE ENCAPSULATED INSIDE AT LEAST ONE ELEMENT THEREOF AND METHOD FOR ENCAPSULATING SAID AT LEAST ONE PORTION OF AN ELECTRONIC DEVICE INSIDE SAID AT LEAST ONE ELEMENT OF A GLASSES FRAME

(71) Applicant: LUXOTTICA S.R.L., Agordo (BL) (IT)

(72) Inventors: Fabio BORSOI, Vittorio Veneto (TV) (IT); Gianluca FANDELLA, Belluno (BL) (IT); Davide VENTURI, Bologna (BO) (IT); Dino MICHELON, Ponte nelle Alpi (BL) (IT)

(21) Appl. No.: 18/688,605

(22) PCT Filed: Aug. 30, 2022
(86) PCT No.: PCT/IB2022/058103

§ 371 Date: Mar. 1, 2024

(30) Foreign Application Priority Data
Sep. 2, 2021 (IT) 102021000022775

(51) Int. Cl. G02C 11/00; B29D 12/02; B29K 1/00

(52) U.S. Cl. CPC G02C 11/10; B29D 12/02; B29K 2001/12

(57) ABSTRACT

Glasses frame including at least one portion of an electronic device encapsulated inside at least one element of the glasses frame, wherein at least one element of the glasses frame includes a plasticized cellulose acetate mixture, wherein the composition of the mixture provides that at least one portion of the at least one element inside which at least one portion of the electronic device is encapsulated, having at least a negligible mass percentage of at least one solvent.

### CROSS-REFERENCE TO RELATED APPLICATIONS

This application is a 35 U.S.C. § 371 National Stage patent application of PCT/IB2022/058103, filed on 30 Aug. 2022, which claims the benefit of Italian patent application 102021000022775, filed on 2 Sep. 2021, the disclosures of which are incorporated herein by reference in their entirety.

### TECHNICAL FIELD

The present disclosure relates to a glasses frame comprising at least one portion of an electronic device encapsulated inside at least one element thereof and a method for encapsulating said at least one portion of an electronic device inside said at least one element of a glasses frame.

### BACKGROUND

In the state of the art, glasses are known having at least one portion of the frame that comprises electronic devices.

Known methods for incorporating electronic devices inside a portion of the glasses frame consist of starting with two rigid sheets of cellulose acetate that will constitute the frame portion, wherein the sheets are composed solely of polymer, plasticizer and any additives. At least one of two plastic surfaces of the two sheets is hollowed out by removing material, creating a cavity capable of housing at least some of the electronic elements of the electronic device. The latter are deposited in the volume of the cavity thus created and the two sheets are then joined together. The joining of the two parts of cellulose acetate can be carried out using different methods.

One such method, as for example explained in U.S. Ser. No. 10/088,695B2, involves the use of a solvent that is placed over the surface of at least one of the two portions of the sheets to be joined and the subsequent application of pressure in the direction perpendicular to a bonding plane and the application of a temperature adapted to allow the solvent to evaporate and the acetate to sinter, cementing the two sheets together. Other methods allow the coupling of the two sheets by applying sufficiently high temperatures and pressures to bring the plastic material at the two sheet surfaces above melting point. This allows the cellulose acetate to solidify into a single block once the temperature is lowered at the end of coupling.

Disadvantageously, encapsulated electrical devices must withstand pressure and temperature stress, but some components of electronic devices cannot withstand temperatures sometimes exceeding 100° C.

Another applicable methodological solution is to pressurize the two parts of the material and induce heating of the plastic material using radio frequencies, such as microwaves. The latter method allows more precise heating of only a superficial area of the two portions of the sheets to be joined up to the melting point.

Disadvantageously, encapsulation methods for electronic devices leave delamination and marks of poor aesthetic quality that could lead to cracks and breakage of the frame.

### SUMMARY

The present disclosure realizes a glasses frame in which at least one portion of an electronic device is encapsulated inside at least one element of a glasses frame by overcoming the disadvantages of the prior art, realizing a better encapsulation that does not leave any marks and wherein the frame is more resistant and flexible and more resistant to delamination phenomena.

The disclosure also relates to a method for encapsulating at least one portion of an electronic device inside at least one element of a glasses frame that overcomes the drawbacks of the prior art.

According to the disclosure, this is achieved by providing a frame according to an independent claim and by a method according to another independent claim.

Other features are provided in the dependent claims.

### BRIEF DESCRIPTION OF THE DRAWINGS

The features and advantages of the present disclosure will be more apparent from the following description, which is to be understood as exemplifying and not limiting, with reference to the appended schematic drawings, in which:

FIG. 1 is a side view of a portion of an element of a glasses frame according to the disclosure which encapsulates inside it a portion of an electronic device according to the present disclosure;

FIG. 2 is a schematic view of one step of inserting said portion of the electronic device between two sheets which, once sintered, will constitute the portion of the frame element that incorporates the portion of the electronic device within itself;

FIG. 3 is a schematic view of a rigid electronic card, which is a portion of the electronic device mounted with a mechanically coupled metal core (rail, pocket, interlocking);

FIG. 4 shows another flexible printed circuit (FPC) glued onto the metal core; and

FIG. 5 shows an electronic card with a metal core.

### DETAILED DESCRIPTION OF THE DRAWINGS

With reference to the aforementioned figures, a glasses frame 10 comprising at least one portion of an electronic device 20 encapsulated within an element 11 of the glasses frame 10 is shown by means of a method for encapsulating at least one portion of said electronic device 20 inside at least one element 11 of a glasses frame 10.

An element 11 means, for example, a nose pad, a bridge or an arm of the glasses frame 10.

In the figures the electronic device 20 comprises a portion encapsulated inside at least one portion 12 of the element 11 of the frame 10 and a portion protruding at least partially outside 21.

The portion protruding at least partially outside 21 of the element 11 is, for example, a connector for supplying power to the electronic device 20 or a connector for data exchange with the electronic device 20.

Said at least one element 11 of said glasses frame 10 is comprised of a mixture of plasticized cellulose acetate suitable for passing from a first composition to a second composition.

Said first composition of said plasticized cellulose acetate mixture comprises a solvent dissolved in the mixture.

Preferably the solvent dissolved in the first mixture is comprised in a list including at least one from acetone, ethanol, ethyl acetate, ethyl lactate.

This first composition comprising plasticized cellulose acetate and solvent comprises a lower softening point than the softening point of plasticized cellulose acetate alone.

Said second composition of said mixture provides that at least one portion 12 of said at least one element 11 inside which said at least one portion of said electronic device 20 is incorporated comprises a negligible mass percentage of solvent, for example, a percentage of less than 2% by weight. It is to be understood that this negligible mass percentage value should be understood merely as an example, and not as limiting the disclosure.

The inventive method, for realizing the frame 10 described and claimed, comprises steps in temporal succession.

The method comprises a first step wherein said at least one element 11 of said glasses frame 10 comprises two elements 111, 112 arranged in a plane and separated, both made of said first composition of said mixture. More generally said two elements 111, 112 can be defined as sheets.

Following the first step, the method provides for a second step involving the insertion of said at least one portion of said electronic device 20 between said two separate sheets 111, 112.

Thereafter, the method comprises a third step comprising increasing a temperature to the softening point of said mixture comprising at least one from plasticized cellulose acetone and solvent present in said at least one portion 12 of said at least one element 11 and applying a contact pressure between said two separate sheets 11, 112.

Subsequently the method comprises a fourth step providing waiting for a period of time sufficient to allow the two separate and partially softened sheets 111, 112 to encapsulate between them said at least one portion of said electronic device 20.

Partial softening refers to the fact that the solvent gives the first mixture a lower softening temperature than the softening temperature of the plasticized cellulose acetate, so not all of the material is sintered and a part of it softens.

Subsequently the method comprises a fifth step providing that said at least one solvent evaporates by passing the composition of the mixture of said at least one portion 12 of said at least one element 11 from the first to the second composition by completing sintering between the two sheets 111, 112 and encapsulating said at least one portion of electronic device 20 inside said at least one portion 12 of said at least one element 11.

Once said at least one portion of said electronic device 20 is encapsulated inside said at least one portion 12 of said at least one element 11 of the frame 10 it will be noted that said at least one portion 12 of said at least one element 11 inside which at least one portion of said electronic device 20 is encapsulated comprising a negligible mass percentage of solvent.

This method is derived from the use of a specific production technology for plasticized cellulose acetate elements, called Complex Solvent Block. In this type of process, the pure cellulose acetate polymer powder is mixed with plasticizer and one or more solvents, which are capable of solvating the polymer itself and any additives. The resulting formulation is mixed until obtaining a uniform mixture with the appearance of a viscous paste, rich in solvent inside. This paste can then be mechanically and thermally processed into various geometries, such as sheets 111, 112 and/or cubes of arbitrarily variable thickness and size, and generally other two- or three-dimensional geometries.

During this first step, it is also possible to introduce dyes of various kinds.

These elements are then mixed together in a mould, to which sufficient pressure and temperature are applied to ensure sintering into a single block; hence the nomenclature of solvent block. The resulting block still contains a high percentage of solvent in its matrix and can be sliced into sheets 111, 112 of arbitrary thickness and other geometries. These sheets 111, 112 are again coupled together by the application of temperature and pressure.

The applied temperature is far below the softening point of the plasticized cellulose acetate. In fact, the processing point of the plasticized acetate is comprised between 18° and 200° C., while the applied temperature is less than 90° C., as it is sufficient to leverage the solvent already present within the material to ensure that the polymer at the interface between two elements has sufficient mobility to penetrate into the surface, with which it is in contact. This whole methodology is therefore called Complex Solvent Block.

The second step of the method comprises inserting at least one portion of said electronic device 20 of any shape, even irregular, at least between two elements 111, 112 arranged in a plane, obtained from the first step and subsequently proceeding to the sintering of the fourth step after passing through the third heating step, thereby encapsulating said at least one portion of the electronic device 20 inside the polymer of said at least one portion 12 of said at least one element 11 of the glasses frame 10.

Advantageously, this method does not require a specific preparation of one of the two surfaces of said at least two elements 111, 112 obtained in one plane, e.g. by creating a cavity by exporting material as is performed in the technique of the prior art. In fact, the mixture of the first composition is a polymer rich in said solvent and has its own intrinsic flexibility and malleability, which allows the sheet 111, 112 of the mixture of the first composition to deform by accommodating the shape of the electronic device 20 inserted inside it and ensuring almost total absence of residual cavities. Once said at least one portion of the electronic device 20 is inserted between the two sheets 111, 112, in a configuration that could be described as “sandwich-like”, they are subjected to heating and pressing according to the third step, causing all the material of the mixture of the first composition around the electronic device 20 to come into contact and lead to sintering in a single block. Advantageously, also in this third step of the method, the flexibility of the solvent-rich mixture absorbs a large part of the mechanical stress induced by the pressing of the two sheets 111, 112, preserving the integrity of the electronics 20 inside. Once the encapsulation of said at least one portion of the electronic device 20 has been completed, the portion 12 of element 11 thus obtained as a result of the fourth step behaves like a single block of material without discontinuity in the polymer matrix, excluding the volume occupied by the encapsulated electronic device 20.

Preferably a temperature of less than 90° C., and even more preferably comprised between 30° C. and 50° C., and a pressure of less than 3 bar, is used.

Following the fourth sintering step, the fifth step takes place in which the solvent is evaporated: this process can be conducted either under ambient conditions or in a heated environment to speed up the process.

Advantageously, once the solvent has evaporated from the plastic matrix making the mixture become a second composition, the mechanical behaviour of the material is comparable to that of plasticized and extruded cellulose acetate, including the stiffness of the latter.

This solvent is preferably present in the mixture in a proportion comprised between 5% and 25% by mass.

Even more preferably, the percentage of said at least one solvent in the first composition of the acetate mixture is comprised between 10 and 15% by mass. Advantageously, this mass percentage of solvent in the first composition allows the solvated polymer paste to be processed in precise geometries, while retaining its flexibility and the possibility of low-temperature sintering.

The third step of increasing the temperature of said at least one portion 12 of the element 11 of the frame 10 preferably requires the temperature to be less than 90° C.

The temperature less than 90° C. corresponds to the softening point of the mixture according to the first composition comprising solvent.

Advantageously, this temperature range ensures that the electronics of the electronic device 20 are not damaged, in particular that any batteries of the electronic device 20 are not damaged.

The third step of the method preferably provides for compressing the two sheets 111, 112 at a pressure comprised between 1.5 and 5 bar. Lower pressure leads to incomplete sintering between the two acetate mixture elements, while excessive pressure can result in damage to the electronics or an undesirable relative displacement between the acetate elements and the electronics themselves.

Advantageously, at the end of the fourth step of the method, the adhesion between the two sheets 111, 112 sintered to form said at least one portion 12 of the element 11 leaves no visible adhesion line, as the material is sintered with itself, due to the presence of solvent in the matrix and does not require the creation of pockets.

Due to the presence of solvent, the acetate cements itself, leaving no adhesion lines and creating a continuous and homogeneous material.

Exposing the electronics and battery of the electronic device 20 to high temperatures (80-90° C.) for long periods of time such as days or weeks could be detrimental, so it is advantageously envisaged that the fifth step provides for said at least one portion 12 of said at least one element 11 being dried at low temperatures to prevent possible premature ageing of the battery and so as not to ruin the connectivity and charging of the battery.

Low temperatures are defined as temperatures below the softening temperature of the first composition of the mixture.

The drying cycle takes no less than 5 days at low temperatures, also using a ventilated or vacuum oven.

The study of shrinkage phenomena is also taken into account.

At the end of the fifth step, a post-production step can be envisaged whereby said at least one portion 12 of the element 11 is in the form of an acetate sheet and is successfully flattened after deformation during the drying of the fifth step, preserving the electronics of the electronic device 20 encapsulated inside the element 11.

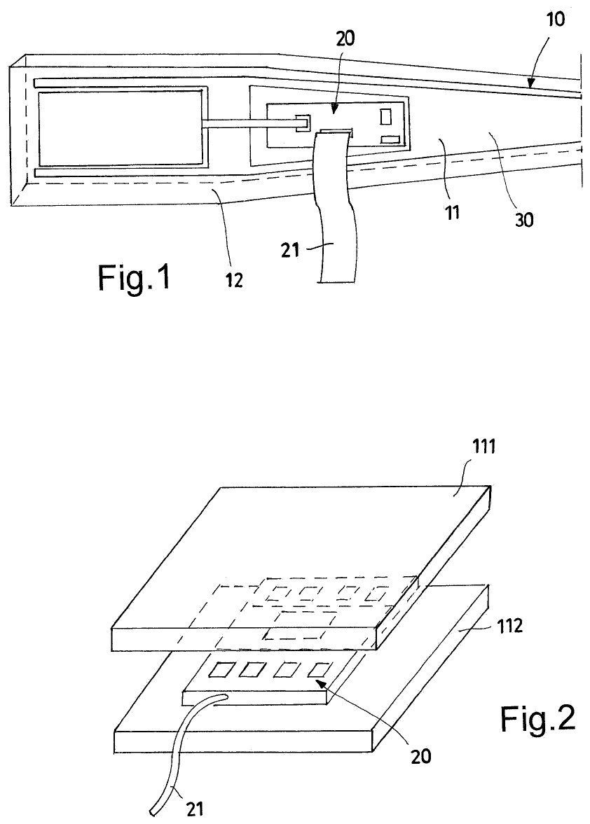

The post-production step provides that said at least one portion 12 of the element 11 once dry is processed around the encapsulated electronic device 20 to form the element 11 of the frame 10, for example an arm shape as shown in FIG. 1.

The third step was tested for example with calendered sheets 111, 112 comprising 15% solvent by mass at a softening temperature T comprised between 25-50° C. and a compression pressure P comprised between 0.5-2.5 bar for a time comprised between 0.5-2.5 hours.

Another test was carried out for pressed and cut sheets 111, 112 comprising 10% by mass of solvent at a softening temperature T comprised between 40-60° C. and a compression pressure P of both sheets 111, 112 comprised between 1 and 10 bar for a time comprised between 1 and 5 hours.

The thickness of the element 11 is finally controlled by several factors such as, for example, the size of the calendered/cut sheet, a thickness gauge applied during the sintering of the fourth step.

The thickness gauge is preferably comprised between 4 and 8 mm.

During the fifth step of drying, the sintered sheet of said at least one portion 12 of said at least one element 11 must be 10-20% thicker than the desired final size.

Finally, a final flattening is carried out, preferably using a second 4 mm thickness gauge.

Advantageously, once dried and flattened, the sheets of said at least one portion 12 of said at least one element 11 can be milled by processing around the encapsulated electronic device 20.

Even more preferably, the electronics of the electronic device 20 are covered with a protective material that can adequately protect the electronics from vibrations and extreme environments with a high concentration of chemical solvents.

The characteristics of the protective material are that it must initially be a low-viscosity fluid so that it completely fills the parts of the electronic device 20, prevents mechanical stress, is impermeable to sensitive reagents such as air or water, and is not corrosive to the electronics.

Curing of this protective material over the electronics takes place at a temperature of less than 60° C. and requires an exothermic process and/or ultraviolet irradiation.

Once it has become solid after sintering, the protective material allows dimensional stability to be maintained.

The protective material is preferably polyurethane, which provides good dimensional stability, good adhesion to the mixture and is safe in contact with the skin.

Advantageously, the method involves covering said electronic device 20 with a protective material, preferably polyurethane, before the second step of the method.

The acetate frame 10 comprises a metal core inside to help limit deformations over time and to allow the shape of the frame itself to be adjusted, e.g. convexity, registration. Solutions that advantageously allow the addition of electronics without compromising this aspect couple an electronic element 20 to a metal structural element, with different construction techniques.

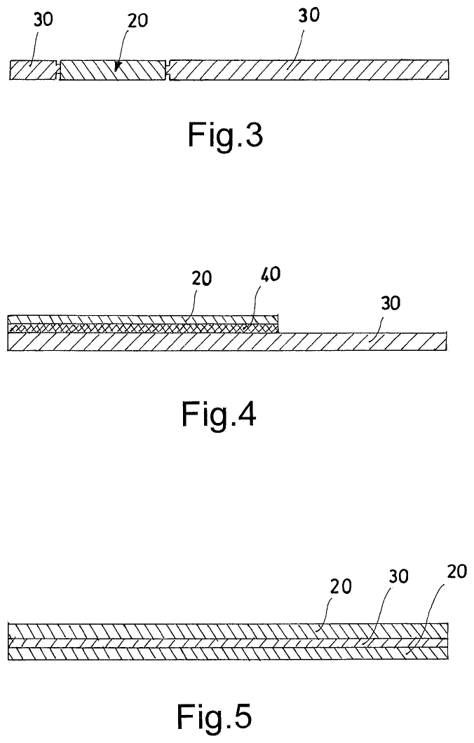

As shown in FIG. 3, the encapsulated portion of the electronic device 20 may be a rigid electronic card integral to a metal core 30 of the arm that is an element 11 of the frame 10 by means of mechanical coupling, such as a mechanical rail, pocket or interlocking coupling.

As shown in FIG. 4, the encapsulated portion of the electronic device 20 may be a flexible printed circuit, so-called FPC, glued by means of an adhesive 40 onto the metal core 30.

FIG. 5 shows an electronic card with a metal core that itself acts as a core 30.

There are at least two tests for recognizing the finished frame 10 of the present disclosure.

The first test comprises detecting the presence of traces of solvent in negligible percentages in the portion 12 of element 11 of the frame 10 where the electronic device 20 is encapsulated, wherein these traces of solvent derive from the physical transformation of the first composition of said mixture into said second composition of said mixture according to the process described above.

The second test is that said at least one portion 12 of element 11 of the frame 10 encapsulating the electronic device 20 is advantageously free from pockets, steps and other junction points between the various portions of the element 11 of the frame 10 encapsulating said at least one portion of the electronic device 20. The portion of the electronic device 20 that is encapsulated inside, for example, the arm, which is one of the elements 11 of the frame 10, turns out to be perfectly encapsulated without being able to distinguish between the walls of the arm 11 and the electronics 20.

Alternatively, a multiplicity of electronic devices 20 can be encapsulated in one or more elements 11 of the glasses frame 10.

Alternatively, only one portion 12 of the element 11 may be made of said first mixture composition.

Alternatively, the first composition of the mixture can be provided to include a multiplicity of solvents with a softening point lower than that of the plasticized cellulose acetate.

The disclosure thus conceived is susceptible to many modifications and variants, all falling within the same inventive concept. In practice, the materials used, as well as their dimensions, can be of any type according to the technical requirements.

1. A glasses frame comprising at least one portion of an electronic device encapsulated inside at least one element of said glasses frame,
wherein said at least one element of said glasses frame is comprised of a plasticized cellulose acetate mixture, and
wherein said composition of said mixture provides at least one portion of said at least one element within which at least one portion of said electronic device is encapsulated, comprises at least a negligible mass percentage of at least a solvent.

2. The frame according to claim 1, wherein said at least one portion of said element of the frame encapsulating the electronic device has no pockets, steps, or other junction points.

3. The frame according to claim 1, wherein said at least one solvent is present in the portion of the element in a percentage lower than 2% by weight.

4. The frame according to claim 1, wherein said at least one solvent is included in a list comprising at least one among acetone, ethanol, ethyl acetate, ethyl lactate.

5. The frame according to claim 1, wherein said at least one solvent derives from a physical transformation of said at least one portion of said at least one element inside which said at least one portion of said electronic device is encapsulated,
wherein said physical transformation provides that said mixture of plasticized cellulose acetate of which said at least one element of said glasses frame is made passes from a first composition to a second composition,
wherein said first composition of said plasticized cellulose acetate mixture comprises said at least one solvent dissolved in the mixture, and
wherein said first composition comprises a softening point lower than a softening point of the plasticized cellulose acetate.

6. The frame according to claim 5, wherein the softening point of said first composition is lower than 90° C.

7. The frame according to claim 5, wherein the softening point of said first mixture is comprised between 30° C. and 50° C.

8. The frame according to claim 5, wherein said at least one solvent is present in the first composition of the mixture in a percentage comprised between 5% and 25% by mass.

9. The frame according to claim 5, wherein said at least one solvent is present in the first composition of the mixture in a percentage comprised between 10 and 15% by mass.

10. The frame according to claim 1, wherein said at least one element of glasses frame is comprised in a list including a nose piece, a bridge, an arm of the glasses frame.

11. The frame according to claim 1, wherein said electronic device is covered with a protective material, preferably polyurethane.

12. The frame according to claim 1, wherein said at least one portion of the electronic device is mounted with a metal core.

13. A method for encapsulating at least one portion of an electronic device inside at least one element of a glasses frame,
wherein said at least one element of said glasses frame is comprised of a mixture of plasticized cellulose acetate suitable for passing from a first composition to a second composition,
wherein said first composition of said plasticized cellulose acetate mixture comprising at least one solvent dissolved in the mixture,
wherein said first composition has a softening point lower than a softening point of the plasticized cellulose acetate,
wherein said second composition of said mixture provides that at least a portion of said at least one element within which said at least a portion of said electronic device is incorporated comprises a negligible quantity of said at least one solvent,
wherein the method includes the following steps:
a first step providing that said at least one element of the glasses frame comprises two separate sheets comprised of said first composition of said mixture,
a second step providing the insertion of said at least one portion of said electronic device between said two separate sheets,
a third step providing increasing a temperature up to the softening point of said first composition present in said at least one portion of said at least one element and applying a contact pressure between said two separate sheets,
a fourth step providing waiting for a period of time sufficient to allow the two separate and partially softened sheets to encapsulate between them said at least a portion of said electronic device, and
a fifth step providing evaporating said at least one solvent by passing the composition of the mixture of said at least one portion of said at least one element from the first to the second composition by carrying out a sintering between the two sheets and encapsulating said at least one portion of electronic device inside said at least one portion of said at least one element.

14. The method according to claim 13, wherein said at least one solvent is present in the first composition of the mixture in a percentage comprised between 5% and 25% by mass.

15. The method according to claim 13, wherein the percentage of said at least one solvent in the first composition of the acetate mixture is comprised between 10% and 15% by mass.

16. The method according to claim 13, wherein the percentage of said at least one solvent in the second composition of the acetate mixture is lower than 2% by weight.

17. The method according to claim 13, wherein said at least one solvent is included in a list comprising at least one of acetone, ethanol, ethyl acetate, ethyl lactate.

18. The method according to claim 13, wherein the softening point of said first composition is lower than 90° C.

19. The method according to claim 13, wherein the softening point of said first mixture is comprised between 30° C. and 50° C.

20. The method according to claim 13, wherein the third step of the method provides for compressing the two sheets to a pressure of less than 3 bar.

21. The method according to claim 13, wherein the method further includes a post-production step providing that said at least one portion of said at least one element has a sheet-form is flattened during drying of the fifth step after said sheet had been deformed by the third and fourth step of the method.

22. The method according to claim 21, wherein said post-production step provides that said at least one portion of said at least one element, once dry, is processed around the encapsulated electronic device to realise the element of the frame.

23. The method according to claim 13, wherein said fifth step provides that said at least one portion of said at least one element is dried at low temperatures, by low temperatures being meant temperatures lower than the softening temperature of the first composition of the mixture.

24. The method according to claim 13, wherein at least one element of glasses frame is included in a list which providing a nose piece, a bridge, an arm of the glasses frame.

25. The method according to claim 13, wherein said electronic device is covered with a protective material, before the second step of the method.
